(19) United States
(12) Patent Application Publication
(10) Pub. No.: US 2024/0243512 A1
(43) Pub. Date: Jul. 18, 2024

(54) CONNECTOR

(71) Applicant: SUMITOMO WIRING SYSTEMS, LTD., Mie (JP)

(72) Inventor: Ayaka NITO, Mie (JP)

(21) Appl. No.: 18/029,037

(22) PCT Filed: Aug. 3, 2021
(86) PCT No.: PCT/JP2021/028815

§ 371 Date: Aug. 11, 2023

(30) Foreign Application Priority Data
Oct. 14, 2020 (JP) 2020-172951

(51) Int. Cl. H01R 13/52; H01R 13/506; H01R 13/508

(52) U.S. Cl. CPC H01R 13/5208; H01R 13/506; H01R 13/508

(57) ABSTRACT

One embodiment of the present invention provides a connector in which ease of assembly can be improved. A connector (1) according to the one embodiment of the present invention comprises: a housing (10) having an accommodation section (11) through which electric wires (W (W1, W2)) pass; a seal member (20) that seals the gap between the inner surface of the accommodation section (11) and the outer peripheral surface of the electric wires (W (W1, W2)); and a retainer (30) that is fixed to the housing (10) and prevents detachment of the seal member (20). The retainer (30) includes a first retainer (40) and a second retainer (50) that overlap with the seal member (20) in the length direction of the electric wires (W (W1, W2)).

### TECHNICAL FIELD

The present disclosure relates to a connector.

### BACKGROUND ART

For example, a waterproof connector disclosed in Patent Document 1 is provided with terminal fittings connected to ends of wires, a connector housing, into which the terminal fittings inserted, rubber plugs to be inserted into the connector housing and each including a wire insertion hole capable of being in close contact with the outer peripheral surface of the wire, and a rubber plug cover for retaining the rubber plugs. The rubber plug cover includes wire through holes, through which the wires are insertable, at positions corresponding to the wire insertion holes.

### PRIOR ART DOCUMENT

### Patent Document

Patent Document 1: JP 2010-015834 A

### SUMMARY OF THE INVENTION

### Problem to be Solved

In the above connector, an improvement in the assemblability of a retainer for fixing the rubber plugs in the housing is desired and there has been a room for improvement in this point.

The present disclosure aims to provide a connector capable of improving assemblability.

### Means to Solve the Problem

The present disclosure is directed to a connector with a housing including an accommodating portion, a wire penetrating through the accommodating portion, a sealing member for sealing between an inner surface of the accommodating portion and an outer peripheral surface of the wire, and a retainer for retaining the sealing member by being fixed to the housing, the retainer including a first retainer and a second retainer overlapping in a length direction of the wire with respect to the sealing member.

### Effect of the Invention

According to the present disclosure, it is possible to provide a connector capable of improving assemblability.

### BRIEF DESCRIPTION OF THE DRAWINGS

FIG. 1 is a perspective view of a connector according to an embodiment.

FIG. 2 is a front view of the connector viewed from the side of wires.

FIG. 3 is a section along 3-3 of FIG. 2.

FIG. 4 is an exploded perspective view of the connector.

FIG. 5 is a diagram showing the mounting of a retainer on a housing.

FIG. 6 is a diagram showing the mounting of the retainer on the housing.

FIG. 7 is a partial section of the connector showing an engaged part of a first retainer and a second retainer.

FIG. 8 is a perspective view showing a connector of a modification.

### DETAILED DESCRIPTION TO EXECUTE THE INVENTION

### Description of Embodiments of Present Disclosure

First, embodiments of the present disclosure are listed and described.
[1] The connector of the present disclosure is provided with a housing including an accommodating portion, a wire penetrating through the accommodating portion, a sealing member for sealing between an inner surface of the accommodating portion and an outer peripheral surface of the wire, and a retainer for retaining the sealing member by being fixed to the housing, the retainer including a first retainer and a second retainer overlapping in a length direction of the wire with respect to the sealing member.

According to this configuration, assemblability can be improved by constituting the retainer for retaining the sealing member by the first and second retainers overlapping in the length direction of the wire.
[2] Preferably, the first retainer includes a first insertion hole, the wire being inserted through the first insertion hole, and a first introducing groove extending from the first insertion hole to an end part of the body portion, and the second retainer includes a second insertion hole, the wire being inserted through the second insertion hole, and a second introducing groove extending from the second insertion hole in a direction different from that of the first introducing groove.

According to this configuration, since the wire can be inserted into the first insertion hole from the first introducing groove with respect to the first retainer and the wire can be inserted into the second insertion hole from the second introducing groove with respect to the second retainer, the first and second retainers can be mounted on the housing after the wire is passed through the housing, and assemblability can be improved.
[3] Preferably, the housing includes a first locking protrusion and a second locking protrusion on a peripheral surface, the first retainer includes a first body portion overlapping the sealing member in the length direction of the wire and a first mounting portion for mounting the first body portion on the housing by being engaged with the first locking protrusion, and the second retainer includes a second body portion overlapping the first body portion in the length direction of the wire and a second mounting portion for mounting the second body portion on the housing by being engaged with the second locking protrusion.

According to this configuration, the first and second retainers can be overlapped in the length direction of the wire and easily mounted on the housing.
[4] Preferably, the first and second locking protrusions are arranged to be shifted in a circumferential direction of the housing, and the first and second mounting portions are arranged to be shifted in the circumferential direction of the housing.

According to this configuration, the shape enlargement of the connector can be suppressed as compared to the case where the first and second locking protrusions, and the first and second mounting portions overlap in the circumferential direction of the housing.
[5] Preferably, the second retainer includes a locking/covering portion for covering the first mounting portion of the first retainer.

According to this configuration, the disengagement of the first mounting portion covered by the locking/covering portion of the second retainer from the first locking protrusion can be suppressed and the detachment of the retainer can be suppressed.
[6] Preferably, the second retainer includes a first divided retainer and a second divided retainer for sandwiching the wire in a radial direction of the wire, and the first and second divided retainers have the same shape.

According to this configuration, an increase of component cost can be suppressed since the second retainer can be configured, using one type of divided retainers as the first and second divided retainers.
[7] Preferably, each of the first and second divided retainers includes a third locking protrusion, a third mounting portion to be engaged with the third locking protrusion and a locking/covering portion for covering the third locking protrusion and the third mounting portion.

According to this configuration, since the third mounting portions can be prevented from being inadvertently deflected and disengaged from the third locking protrusions, the separation of the first and second divided retainers can be suppressed and the detachment of the second retainer can be more suppressed.

### Details of Embodiment of Present Disclosure

A specific example of a connector of the present disclosure is described with reference to the drawings. Some of components may be shown in an exaggerated or simplified manner for the convenience of description in each figure. Further, a dimension ratio of each part may be different in each figure. “Parallel” and “orthogonal” in this specification mean not only strictly parallel and orthogonal, but also substantially parallel and orthogonal within a range in which functions and effects in this embodiment are achieved. Note that the present invention is not limited to these illustrations, but is represented by claims and intended to include all changes in the scope of claims and in the meaning and scope of equivalents.

### (Overall Configuration of Connector)

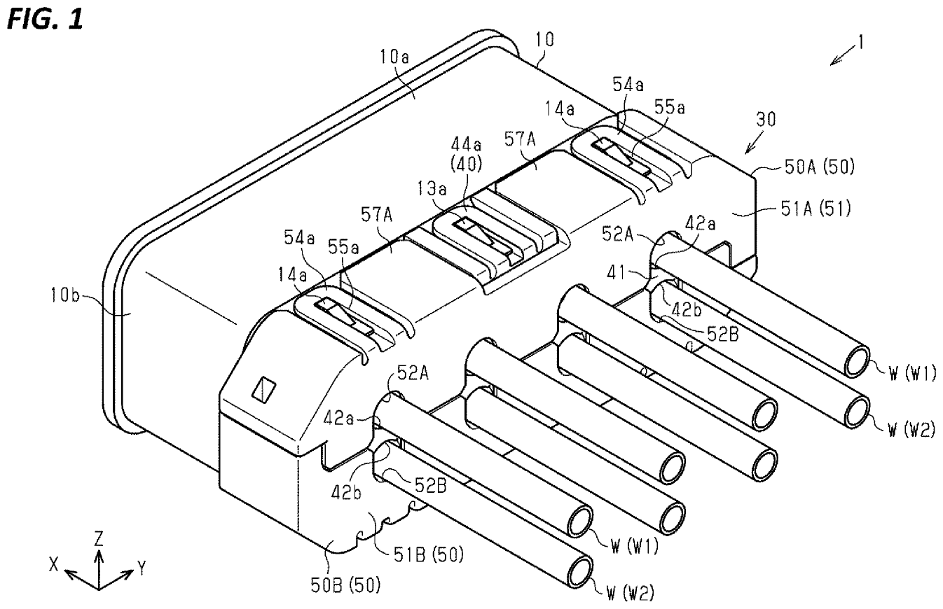

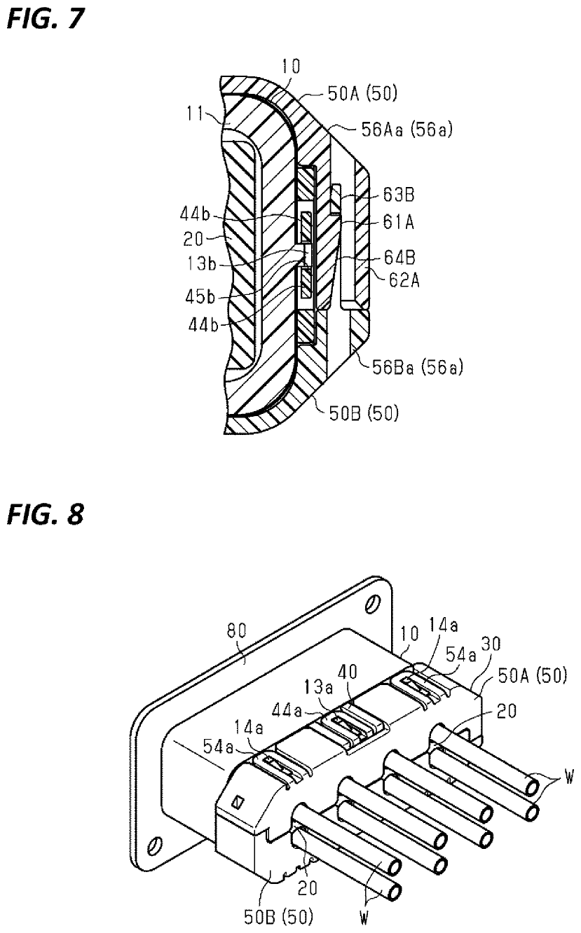

A connector 1 shown in FIGS. 1 to 7 connects a plurality of (eight in this embodiment) wires W to a target such as an electrical device. In each figure, an X direction is a length direction of the wires W, a direction orthogonal to the X direction is a Y direction and a direction orthogonal to the X direction and Y direction is a Z direction.

The connector 1 includes a housing 10, a plurality of sealing members 20 and a retainer 30.

The housing 10 is, for example, a member made of an insulating resin material. The housing 10 is formed into a rectangular parallelepiped long in the Y direction. The housing 10 has a pair of first side surfaces 10a facing opposite to each other in the Z direction, a pair of second side surfaces 10b facing opposite to each other in the Y direction and a third side surface 10c facing the wires W.

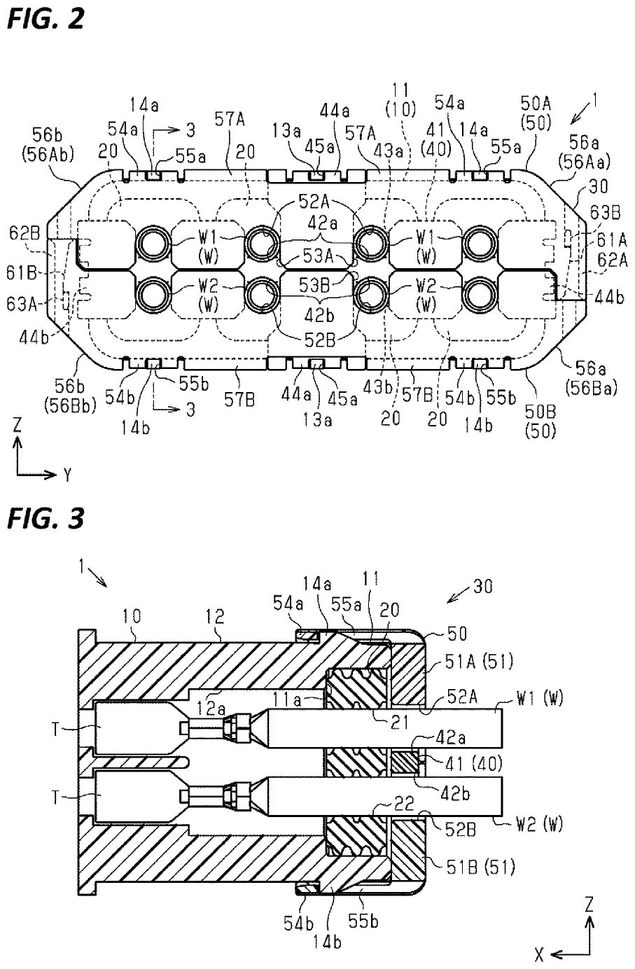

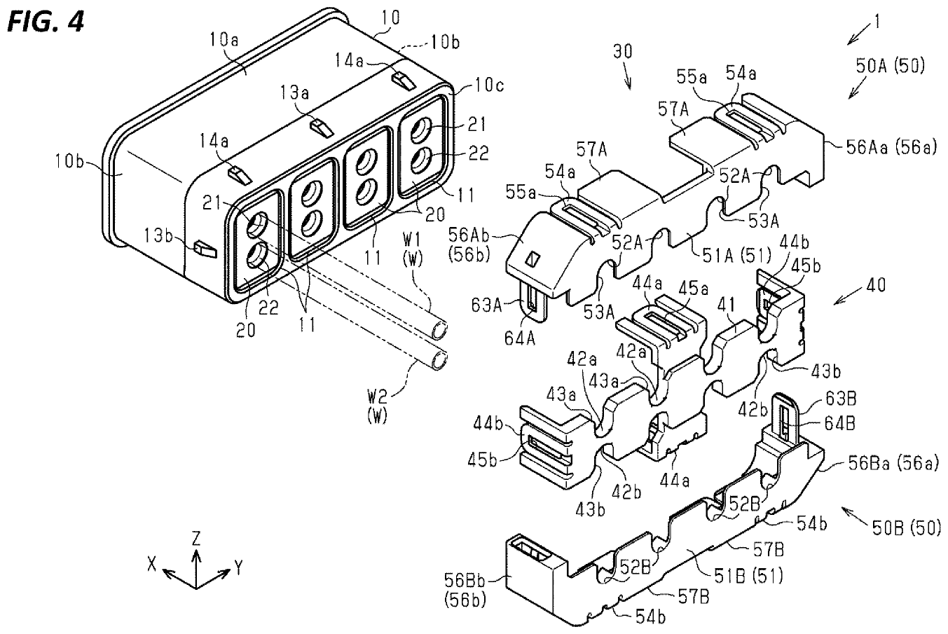

As shown in FIGS. 2 and 4, the housing 10 includes a plurality of (four in this embodiment) accommodating portions 11. The accommodating portions 11 are arranged along the Y direction. Each accommodating portion 11 is formed into a rectangular shape long in the Z direction when viewed from the side of the wires W. The sealing member 20 is accommodated into each accommodating portion 11.

The sealing member 20 is formed by a resilient member of rubber or the like. The outer shape of the sealing member 20 is larger than inside dimensions of the inner peripheral surface of the accommodating portion 11. Thus, the sealing member 20 is accommodated in the accommodating portion 11 while being held in close contact with the inner peripheral surface of the accommodating portion 11.

The sealing member 20 includes two through holes 21, 22, through which the wires W are passed. The two through holes 21, 22 are arranged in the Z direction. An inner diameter of each through hole 21, 22 is smaller than an outer diameter of the wire W. Thus, the sealing member 20 is externally fit to the wires W while being held in close contact with the outer peripheral surfaces of the wires W.

Each of four sealing members 20 arranged in the Y direction includes two through holes 21, 22 and the wire W is passed through each through hole 21, 22. Accordingly, the housing 10 and the four sealing members 20 hold two rows of the wires W arranged in the Y direction, which is a longitudinal direction of the housing 10. Each row is composed of four wires W. In this embodiment, the row of the wires W passed through the first through holes 21 of the sealing members 20 is referred to as a first row of wires W1 and the row of the wires W passed through the second through holes 22 of the sealing members 20 is referred to as a second row of wires W2.

The wire W includes a core wire Wa constituted by a conductor and an insulation coating Wb covering the outer periphery of the core wire Wa. A stranded wire formed by stranding a plurality of metal strands, a columnar conductor constituted by one columnar metal bar having a solid structure inside, a tubular conductor having a hollow structure inside or the like can be, for example, used as the core wire Wa. A combination of a stranded wire, a columnar conductor and/or a tubular conductor may be, for example, used as the core wire Wa. A single core wire, a busbar and the like can be, for example, cited as the columnar conductor. The core wire Wa of this embodiment is a stranded wire. A copper-based or aluminum-based metal material can be, for example, used as a material of the core wire Wa. Each wire W may be a shielded wire having an electromagnetic shielding structure itself or may be a non-shielded wire having no electromagnetic shielding structure itself.

As shown in FIG. 3, the housing 10 includes penetration portions 12. The penetration portions 12 extend in the X direction from inner surfaces 11a of the accommodating portions 11. The penetration portion 12 includes a through hole 12a, through which the wires W are passed. An inner diameter of the through hole 12a is smaller than inner dimensions of the accommodating portion 11. Therefore, the sealing member 20 accommodated into the accommodating portion 11 is in contact with the inner surface 11a of the accommodating portion 11, which can be a step between the inner peripheral surface of the through hole 12a and the inner peripheral surface of the accommodating portion 11.

In this embodiment, the housing 10 accommodates connection terminals T mounted on the tips of the wires W. The connection terminal T is, for example, a female terminal and connected to a terminal of a connection target such as an electrical device. Note that the connection terminal T can be changed as appropriate and may be connected to the terminal of the connection target, for example, by a screw or the like. Further, the connection terminal T may be located outside the housing 10. Further, the connection terminal T may be omitted and the tip of the wire W passed through the housing 10 may be located outside the housing 10.

First locking protrusions 13a, 13b and second locking protrusions 14a, 14b are formed on the outer peripheral surface of the housing 10 on the side of the third side surface 10c. The first locking protrusions 13a are formed in central parts in the Y direction on the pair of first side surfaces 10a. The first locking protrusions 13b are formed in central parts in the Z direction on the pair of second side surfaces 10b. The second locking protrusions 14a, 14b are formed at positions on opposite sides of the first locking protrusion 13a on each of the pair of first side surfaces 10a. The first locking protrusions 13a, 13b and the second locking protrusions 14a, 14b are formed into such a shape that a height is gradually reduced toward the third side surface 10c. The retainer 30 is mounted on the housing 10 by the first locking protrusions 13a, 13b and the second locking protrusions 14a, 14b.

### (Retainer)

The retainer 30 is mounted on the housing 10 and retains the sealing members 20. The retainer 30 is formed of an insulating resin material or the like. The retainer 30 includes a first retainer 40 and a second retainer 50. The first and second retainers 40, 50 overlap each other in the length direction of the wires W, i.e. in the X direction.

### (First Retainer)

The first retainer 40 is mounted on the housing 10 by the first locking protrusions 13a, 13b. The first retainer 40 includes a first body portion 41 and first mounting portions 44a, 44b.

As shown in FIGS. 2, 4 and 5, the first body portion 41 is in the form of a rectangular plate long in the Y direction. The first body portion 41 includes first insertion holes 42a, 42b, into which the wires W are inserted, and first introducing grooves 43a, 43b extending from the first insertion holes 42a, 42b to end parts of the first body portion 41. As shown in FIG. 3, the first insertion hole 42a, through which the wire W1 of the first row is inserted, is formed to communicate with the first through hole 21 of the sealing member 20. The second insertion hole 42b, through which the wire W2 of the second row is inserted, is formed to communicate with the second through hole 22 of the sealing member 20. The first insertion holes 42a, 42b have a diameter slightly larger than the diameter of the wire W (W1, W2) to be inserted therethrough.

The first introducing groove 43a extending from the first insertion hole 42a extends upwardly of the housing 10 in the Z direction. The first introducing groove 43b extending from the first insertion hole 42b extends downwardly of the housing 10 in the Z direction. That is, the first introducing grooves 43a, 43b extend in mutually different directions from the first insertion holes 42a, 42b. A width of the first introducing grooves 43a, 43b is set to be equal to the diameter of the first insertion holes 42a, 42b.

The wire W1 of the first row is arranged into the first insertion hole 42a via the first introducing groove 43a from above the first body portion 41, i.e. from an opening side of the first introducing groove 43a. The wire W2 of the second row is arranged into the second insertion hole 42b via the second introducing groove 43b from below the first body portion 41, i.e. from an opening side of the first introducing groove 43b.

The first mounting portions 44a, 44b extend in parallel to the outer surface of the housing 10 from the first body portion 41. The first mounting portions 44a, 44b are in the form of elongated plates. The first mounting portion 44a extends from a part corresponding to the first locking protrusion 13a of the housing 10 toward the first locking protrusion 13a to reach beyond the first locking protrusion 13a. The first mounting portion 44b extends from a part corresponding to the first locking protrusion 13b of the housing 10 toward the first locking protrusion 13b to reach beyond the first locking protrusion 13b. The first mounting portion 44a, 44b includes a locking groove 45a, 45b in a part extending from a base end part to a position before a tip part in an intermediate part in a width direction.

In mounting the first retainer 40 on the housing 10, the first mounting portions 44a, 44b are moved along the outer peripheral surface of the housing 10. The first mounting portions 44a, 44b contact the first locking protrusions 13a, 13b and are resiliently deformed outwardly. When tip parts of the first mounting portions 44a, 44b ride over the first locking protrusions 13a, 13b, the first mounting portions 44a, 44b are resiliently restored into an original shape. In this way, the first locking protrusions 13a, 13b of the housing 10 are fit into the locking grooves 45a, 45b of the first mounting portions 44a, 44b.

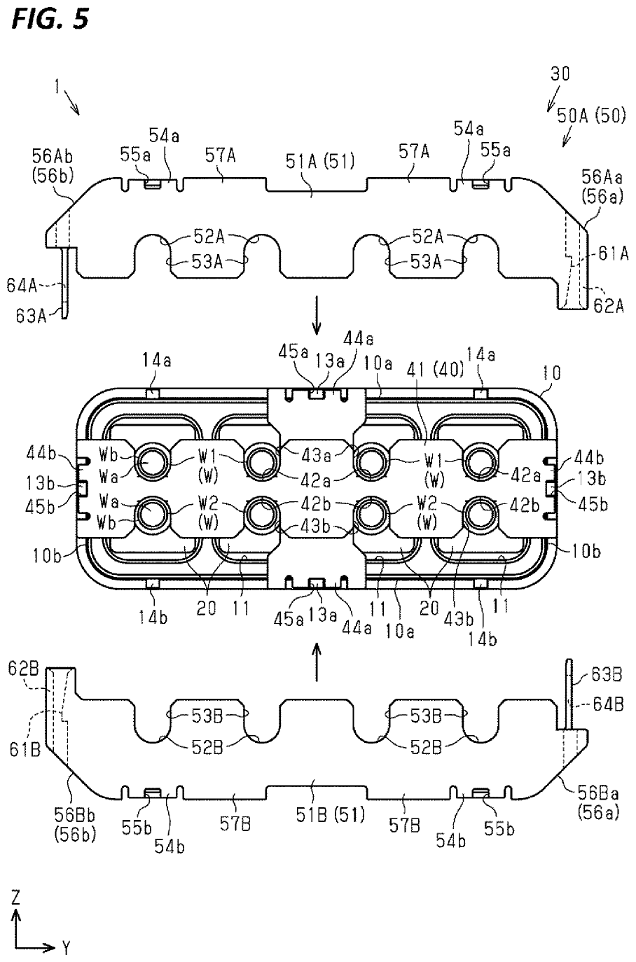

The first retainer 40 is mounted on the housing 10 by fitting the first locking protrusions 13a, 13b of the housing 10 into the locking grooves 45a, 45b of the first mounting portions 44a, 44b. As shown in FIG. 5, the first body portion 41 of the first retainer 40 extends in the Y direction across the plurality of accommodating portions 11 on the side of the third side surface 10c of the housing 10. Therefore, the first body portion 41 of the first retainer 40 overlaps the sealing members 20 accommodated in the respective accommodating portions 11 in the X direction, which is the length direction of the wires W, and retains the sealing member 20.

### (Second Retainer)

The second retainer 50 is mounted on the housing 10 by the second locking protrusions 14a, 14b. The second retainer 50 includes a second body portion 51, second mounting portions 54a, 54b, covering portions 56a, 56b and extending portions 57A, 57B.

The second body portion 51 overlaps the first body portion 41 of the first retainer 40 in the length direction of the wires W (X direction).

The second mounting portions 54a, 54b extend in parallel to the outer peripheral surface of the housing 10 from end parts of the second body portion 51. The second mounting portions 54a, 54b are in the form of elongated plates. The second mounting portion 54a extends from a part corresponding to the second locking protrusion 14a of the housing 10 toward the second locking protrusion 14a to reach beyond the second locking protrusion 14a. The second mounting portion 54b extends from a part corresponding to the second locking protrusion 14b of the housing 10 toward the second locking protrusion 14b to reach beyond the second locking protrusion 14b. The second mounting portion 54a, 54b includes a locking groove 55a, 55b in a part extending from a base end part to a position before a tip part in an intermediate part in the width direction.

Similarly to the first mounting portions 44a, 44b, the second mounting portions 54a, 54b are resiliently deformed by the second locking protrusions 14a, 14b and resiliently restored after tip parts thereof ride over the second locking protrusions 14a, 14b. In this way, the second locking protrusions 14a, 14b of the housing 10 are fit into the locking grooves 55a, 55b of the second mounting portions 54a, 54b. The second retainer 50 is mounted on the housing 10 by fitting the second locking protrusions 14a, 14b of the housing 10 into the locking grooves 55a, 55b of the second mounting portions 54a, 54b.

The covering portions 56a, 56b extend in parallel to the outer peripheral surface of the housing 10 from end parts of the second body portion 51. The second covering portions 56a, 56b are formed to cover the first mounting portions 44b of the first retainer 40 engaged with the first locking protrusions 13b on the second side surfaces 10b of the housing 10. The covering portions 56a, 56b suppress the resilient deformation of the first mounting portions 44b. In this way, the covering portions 56a, 56b suppress the disengagement of the first mounting portions 44b of the first retainer 40 from the first locking protrusions 13b of the housing 10. That is, the second retainer 50 suppresses the detachment of the first retainer 40 from the housing 10.

The extending portions 57A, 57B extend in parallel to the outer peripheral surface of the housing 10 from the end parts of the second body portion 51.

The extending portions 57A, 57B are disposed between the first mounting portions 44a of the first retainer 40 engaged with the first locking protrusions 13a on the first side surfaces 10a of the housing 10 and the second mounting portions 54a, 54b of the second retainer 50. Accordingly, the first mounting portions 44a between the extending portions 57A and 57B are not covered by the second retainer 50. That is, the first mounting portions 44a are exposed from the second retainer 50. In this way, the first mounting portions 44a of the first retainer 40 and the second retainer 50 do not overlap in the Z direction, wherefore the enlargement of the connector 1 in the Z direction can be suppressed.

In this embodiment, the second retainer 50 is composed of a first divided retainer 50A and a second divided retainer 50B divided along the width direction of the connector 1. The width direction of the connector 1 is an arrangement direction of the wires W passed through the housing 10. The second retainer 50 is divided between the wires W1 of the first row and the wires W2 of the second row. The first and second divided retainers 50A, 50B have the same shape.

The first divided retainer 50A includes a first divided body 51A, the second mounting portions 54a, a first divided covering portion 56Aa, a second divided covering portion 56Ab and the extending portions 57A. The second divided retainer 50B includes a second divided body 51B, the second mounting portions 54b, a first divided covering portion 56Ba, a second divided covering portion 56Bb and the extending portions 57B. The second body portion 51 is composed of the first divided body 51A of the first divided retainer 50A and the second divided body 51B of the second divided retainer 50B. The first covering portion 56a is composed of the first divided covering portion 56Aa and the first divided covering portion 56Ba, and the second covering portion 56b is composed of the second divided covering portion 56Ab and the second divided covering portion 56Bb.

As described above, since the first and second divided retainers 50A, 50B have the same shape, the description of the second divided retainer 50B is partially omitted for common parts. Cooperating parts of the first and second divided retainers 50A, 50B are described using the both divided retainers.

As shown in FIGS. 1, 2 and 6, the first divided body 51A includes second insertion holes 52A, through which the wires W1 are passed, and second introducing grooves 53A extending from the second insertion holes 52A. The second insertion hole 52A has a diameter slightly larger than that of the wire W1 to be inserted therethrough. A width of the second introducing groove 53A is set to be equal to the diameter of the second insertion hole 52A. The second divided body 51B includes second insertion holes 52B, through which the wires W2 are passed, and second introducing grooves 53B extending from the second insertion holes 52B.

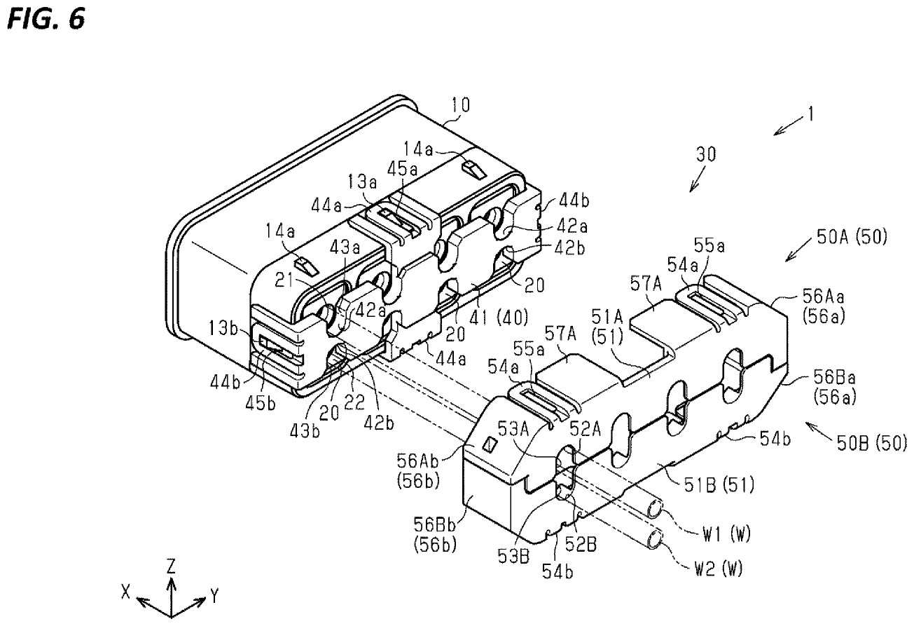

As shown in FIG. 6, with the first and second divided retainers 50A, 50B assembled, the second introducing grooves 53A of the first divided body 51A of the first divided retainer 50A extend toward the second divided retainer 50B and the second introducing grooves 53B of the second divided body 51B of the second divided retainer 50B extend toward the first divided retainer 50A. That is, the second introducing grooves 53A of the first divided retainer 50A and the second introducing grooves 53B of the second divided retainer 50B extend in facing directions opposite to each other.

The first introducing grooves 43a extending from the first insertion holes 42a of the first retainer 40, through which the wires W1 are inserted, extend in a direction different from that of the second introducing grooves 53A of the first divided body 51A. In this embodiment, the first and second introducing grooves 43a, 53A extend in directions opposite to each other. The first and second insertion holes 42a, 52A constitute circular insertion holes when viewed from the length direction of the wires W1.

The first introducing grooves 43b extending from the first insertion holes 42b of the first retainer 40, through which the wires W2 are inserted, extend in a direction different from that of the second introducing grooves 53B of the second divided body 51B. In this embodiment, the first and second introducing grooves 43b, 53B extend in directions opposite to each other. The first and second insertion holes 42b, 52B constitute circular insertion holes when viewed from the length direction of the wires W2.

As shown in FIG. 5, the first divided covering portion 56Aa of the first divided retainer 50A includes a third locking protrusion 61A and a locking/covering portion 62A. The second divided covering portion 56Ab of the first divided retainer 50A includes a third mounting portion 63A. As shown in FIGS. 4 and 5, the third locking protrusion 61A projects outwardly of the first divided retainer 50A. The locking/covering portion 62A is formed to cover the third locking protrusion 61A.

The first divided covering portion 56Ba of the second divided retainer 50B includes a third mounting portion 63B. The second divided covering portion 56Bb of the second divided retainer 50B includes a third locking protrusion 61B and a locking/covering portion 62B.

The third mounting portion 63A is formed to extend in the Z direction. The third mounting portion 63A is in the form of an elongated plate. The third mounting portion 63A extends from a part corresponding to the third locking protrusion 61B of the second divided covering portion 56Bb toward the third locking protrusion 61B to reach beyond the third locking protrusion 61B. The third mounting portion 63A includes a locking groove 64A in a part extending from a base end part to a position before a tip part in an intermediate part in the width direction.

Similarly to the first mounting portions 44a, 44b and the second mounting portions 54a, 54b, the third mounting portions 63A, 63B are resiliently deformed by the third locking protrusions 61B, 61A, and resiliently restored after the tip parts of the third mounting portions 63A, 63B ride over the third locking protrusions 61B, 61A. In this way, the third locking protrusions 61B, 61A are fit into the locking grooves 64A, 64B of the third mounting portions 63A, 63B. The first and second divided retainers 50A, 50B are assembled with each other to form the second retainer 50 by fitting the third locking protrusions 61B, 61A into the locking grooves 64A, 64B of the third mounting portions 63A, 63B thereof.

The locking/covering portions 62A, 62B are formed to cover the third locking protrusions 61A, 61B. Accordingly, the third mounting portions 63A, 63B can be prevented from being inadvertently deflected and disengaged from the third locking protrusions 61A, 61B. In this way, the first and second divided retainers 50A, 50B assembled with each other can be prevented from being separated from each other.

As shown in FIGS. 5 and 6, the first divided retainer 50A is moved toward the second divided retainer 50B from above the wires W1 of the first row with respect to the wires W1 of the first row. The wires W1 of the first row are arranged into the second insertion holes 52A from the second introducing grooves 53A of the first divided retainer 50A. The second retainer 50B is moved toward the first divided retainer 50A from below the wires W2 of the second row with respect to the wires W2 of the second row. The wires W2 of the second row are arranged into the second insertion holes 52B from the second introducing grooves 53B of the second divided retainer 50B.

As shown in FIGS. 5, 6 and 7, the first and second divided retainers 50A, 50B are assembled with each other to form the second retainer 50 by the third mounting portions 63A, 63B and the third locking protrusions 61A, 61B thereof. The plurality of wires W (wires W1 of the first row and wires W2 of the second row) are inserted through the second insertion holes 52A, 52B of this second retainer 50.

### Functions and Effects

Next, functions and effects of the above connector 1 are described.
(1) The connector 1 is provided with the housing 10 including the accommodating portions 11, through which the wires W (W1, W2) are passed, the sealing members 20 for sealing between the inner surfaces of the accommodating portions 11 and the outer peripheral surfaces of the wires W (W1, W2), and the retainer 30 for retaining the sealing members 20 by being fixed to the housing 10. The retainer 30 includes the first and second retainers 40, 50 overlapping in the length direction of the wires W (W1, W2) with respect to the sealing members 20. Therefore, assemblability can be improved by constituting the retainer 30 for retaining the sealing members 20 by the first and second retainers 40, 50 overlapping in the length direction of the wires.
(2) The first retainer 40 includes the first insertion holes 42a, 42b, through which the wires W are inserted, and the first introducing grooves 43a, 43b extending from the first insertion holes 42a, 42b to the end parts of the first body portion 41. The second retainer 50 includes the second insertion holes 52A, 52B, through which the wires W are inserted, and the second introducing grooves 53A, 53B extending from the second insertion holes 52A, 52B in the directions different from those of the first introducing grooves 43a, 43b. Accordingly, the wires W can be inserted into the first insertion holes 42a, 42b from the first introducing grooves 43a, 43b with respect to the first retainer 40. Further, the wires W can be inserted into the second insertion holes 52A, 52B from the second introducing grooves 53A, 53B with respect to the second retainer 50. Thus, the first and second retainers 40, 50 can be mounted on the housing 10 after the wires W are passed through the housing 10, and assemblability can be improved.
(3) The housing 10 includes the first locking protrusions 13a, 13b and the second locking protrusions 14a, 14b on the peripheral surface, and the first retainer 40 includes the first body portion 41 overlapping the sealing members in the length direction of the wires W and the first mounting portions 44a, 44b for mounting the first body portion 41 on the housing 10 by being engaged with the first locking protrusions 13a, 13b. The second retainer 50 includes the second body portion 51 overlapping the first body portion 41 in the length direction of the wires W and the second mounting portions 54a, 54b for mounting the second body portion 51 on the housing 10 by being engaged with the second locking protrusions 14a, 14b. Therefore, the first and second retainers 40, 50 can be overlapped in the length direction of the wires W and easily mounted on the housing 10.
(4) The first locking protrusions 13a, 13b and the second locking protrusions 14a, 14b are arranged to be shifted in a circumferential direction of the housing 10. The first mounting portions 44a, 44b and the second mounting portions 54a, 54b are arranged to be shifted in the circumferential direction of the housing 10. Therefore, the shape enlargement of the connector can be suppressed as compared to the case where the first locking protrusions 13a, 13b and the second locking protrusions 14a, 14b, and the first mounting portions 44a, 44b and the second mounting portions 54a, 54b overlap in the circumferential direction of the housing 10.
(5) The second retainer 50 includes the covering portions 56a, 56b for covering the first mounting portions 44b of the first retainer 40. Therefore, the disengagement of the first mounting portions 44b covered by the covering portions 56a, 56b of the second retainer 50 from the first locking protrusions 13b can be suppressed and the detachment of the retainer 30 can be suppressed.
(6) The second retainer 50 includes the first and second divided retainers 50A, 50B for sandwiching the wires W in radial directions of the wires W, and the first and second divided retainers 50A, 50B have the same shape. Therefore, the second retainer 50 can be configured, using one type of retainers as the first and second divided retainers 50A, 50B, wherefore an increase of component cost can be suppressed.
(7) The first and second divided retainers 50A, 50B include the third locking protrusions 61A, 61B, the third mounting portions 63B, 63A to be engaged with the third locking protrusions 61A, 61B, and the locking/covering portions 62A, 62B for covering the third locking protrusions 61A, 61B and the third mounting portions 63B, 63A. Thus, the third mounting portions 63A, 63B can be prevented from being inadvertently deflected and disengaged from the third locking protrusions 61B, 61A. Therefore, the separation of the first and second divided retainers 50A, 50B can be suppressed, and the detachment of the second retainer 50 can be more suppressed.

### Modifications

This embodiment can be modified and carried out as follows. This embodiment and the following modifications can be carried out in combination without technically contradicting each other.
In the above embodiment, the housing 10 may be a member formed of an electrically conductive metal material. Further, the housing 10 may be composed of a member formed of a resin material and a member formed of a metal material for covering the former member. Further, the housing 10 may be connected to a case constituting the electrical device, may be a part of the case constituting the electrical device or may be a part of a connector to be connected to the electrical device. For example, a housing 10 shown in FIG. 8 includes a flange 80 and is mounted on the electrical device by the flange 80.
The number of the wires W passed through the connector 1 may be appropriately changed to seven or less or nine or more.
The number of the wires W passed through the sealing member 20 may be appropriately changed to one or three or more.
The first and second divided retainers 50A, 50B may be connected to each other, for example, by a hinge.
As in the shown embodiment, the first insertion holes 42a may be open upwardly of the housing 10 when viewed from the length direction of the wires W. The first introducing grooves 43a may extend upwardly of the housing 10 from opening ends of the first insertion holes 42a. The first insertion holes 42b may be open downwardly of the housing 10. The first introducing grooves 43b may extend downwardly of the housing 10 from opening ends of the first insertion holes 42b.
As in the shown embodiment, the second insertion holes 52A may be open downwardly of the housing 10 when viewed from the length direction of the wires W. The second introducing grooves 53A may extend downwardly of the housing 10 from opening ends of the second insertion holes 52A. The second insertion holes 52B may be open upwardly of the housing 10. The second introducing grooves 53B may extend upwardly of the housing 10 from opening ends of the second insertion holes 52B.
As in the shown embodiment, the second insertion holes 52A and the first insertion holes 42a may be configured to vertically sandwich the wires W1 of the first row. The first insertion holes 42b and the second insertion holes 52B may be configured to vertically sandwich the wires W2 of the second row. The second insertion holes 52A, 52B may be configured to vertically sandwich the wires W.
As in the shown embodiment, the numbers of the first locking protrusions 13a, 13 and the corresponding first mounting portions 44a, 44b may be two or more. The numbers of the second locking protrusions 14a, 14b and the corresponding second mounting portions 54a, 54b may be one, three or more.
As in the shown embodiment, the wires W may extend rearward from the housing 10. The third side surface 10c may be referred to as a rear surface. As in an example shown in FIG. 3, the front ends of the wires W and/or the connection terminals T may be arranged in the housing 10 and covered by the housing 10. In the example shown in FIG. 3, the front ends of the wires W and/or the connection terminals T are arranged forward of the sealing member 20. As in the example shown in FIG. 3, each of the plurality of wires W can have the front end, a first axial position separated or adjacent behind the front end, a second axial position separated or adjacent behind the first axial position, and a third axial position separated or adjacent behind the second axial position. The first, second and third axial positions of the wire W may be three consecutive tubular regions in the length direction of the wire W. In the shown embodiment, as shown in FIG. 3, the sealing member 20 may face or directly contact the radially outermost surface of one wire (e.g. wire W1) at the first axial position of the wire W, one insertion hole (e.g. first insertion hole 42a) of the first retainer 40 may face or directly contact the radially outermost surface of the wire W at the second axial position of this wire (e.g. wire W1) and one insertion hole (e.g. second insertion hole 52A) of the second retainer 50 may face or directly contact the radially outermost surface of the wire W at the third axial position of this wire (e.g. wire W1).
The through hole 21 (22) of the sealing member 20 may be referred to as a sealing hole or first wire receiving surface configured to contact the radially outermost surface of the wire W at the first axial position of the wire W in a liquid-tight manner. The first insertion hole 42a (42b) of the first retainer 40 may be referred to as a second wire receiving surface configured to face or directly contact the radially outermost surface of the wire W at the second axial position of the wire W. The second insertion hole 52A (52B) of the second retainer 50 may be referred to as a third wire receiving surface configured to face or directly contact the radially outermost surface of the wire W at the third axial position of the wire W.
As in the example shown in FIG. 3, the first insertion hole 42a, 42b of the first retainer 40 may face or directly contact the radially outermost surface of the corresponding wire W on a sub-surface of this wire W in a first circumferential direction at the second axial position of this wire W. The second insertion hole 52A, 52B of the second retainer 50 may face or directly contact the radially outermost surface of the corresponding wire W at the third axial position of this wire W and, further, face or directly contact the radially outermost surface of the wire W on a sub-surface of this wire W in a second circumferential direction different from the sub-surface in the first circumferential direction of the wire W at the second axial position of this wire W.

### LIST OF REFERENCE NUMERALS

1 connector
10 housing
10a, 10b, 10c side surface
11 accommodating portion
12 penetration portion
13a, 13b first locking protrusion
14a, 14b second locking protrusion
20 sealing member
21, 22 through hole
30 retainer
40 first retainer
41 first body portion
42a, 42b first insertion hole
43a, 43b first introducing groove
44a, 44b first mounting portion
50 second retainer
50A first divided retainer
50B second divided retainer
51 second body portion
51A first divided body portion
51B second divided body portion
52A, 52B second insertion hole
53A, 53B second introducing groove
54a, 54b second mounting portion
56a covering portion (first covering portion)
56b covering portion (second covering portion)
56Aa first divided covering portion
56Ab second divided covering portion
56Ba first divided covering portion
56Bb second divided covering portion
61A, 61B third locking protrusion
62A, 62B locking/covering portion
63A, 63B third mounting portion
T connection terminal
W, W1, W2 wire
Wa core wire
Wb insulation coating

What is claimed is:

1. A connector, comprising:
a housing including an accommodating portion, a wire penetrating through the accommodating portion;
a sealing member for sealing between an inner surface of the accommodating portion and an outer peripheral surface of the wire; and
a retainer for retaining the sealing member by being fixed to the housing,
the retainer including a first retainer and a second retainer overlapping in a length direction of the wire with respect to the sealing member.

2. The connector of claim 1, wherein:
the first retainer includes a first insertion hole, the wire being inserted through the first insertion hole, and a first introducing groove extending from the first insertion hole, and
the second retainer includes a second insertion hole, the wire being inserted through the second insertion hole, and a second introducing groove extending from the second insertion hole in a direction different from that of the first introducing groove.

3. The connector of claim 2, wherein:
the housing includes a first locking protrusion and a second locking protrusion on a peripheral surface,
the first retainer includes a first body portion overlapping the sealing member in the length direction of the wire and a first mounting portion for mounting the first body portion on the housing by being engaged with the first locking protrusion, and
the second retainer includes a second body portion overlapping the first body portion in the length direction of the wire and a second mounting portion for mounting the second body portion on the housing by being engaged with the second locking protrusion.

4. The connector of claim 3, wherein:
the first and second locking protrusions are arranged to be shifted in a circumferential direction of the housing, and
the first and second mounting portions are arranged to be shifted in the circumferential direction of the housing.

5. The connector of claim 3 or 4, wherein the second retainer includes a locking/covering portion for covering the first mounting portion of the first retainer.

6. The connector of claim 5, wherein:
the second retainer includes a first divided retainer and a second divided retainer for sandwiching the wire in a radial direction of the wire, and
the first and second divided retainers have the same shape.

7. The connector of claim 6, wherein each of the first and second divided retainers includes a third locking protrusion, a third mounting portion to be engaged with the third locking protrusion and a locking/covering portion for covering the third locking protrusion and the third mounting portion.
